(19) United States
(12) Patent Application Publication
(10) Pub. No.: US 2013/0145251 A1
(43) Pub. Date: Jun. 6, 2013

(54) Laying Out Displaying Media Content Across Heterogeneous Computing Devices

(71) Applicants: Imad Maurice Jureidini, Arlington, MA (US); Maurice Bennett Shore, Carlisle, MA (US); William Frederick Kiefer, III, Cambridge, MA (US); Sami Mohammed Shalabi, Winchester, MA (US); Cassandra Lynn Doll, Santa Clara, CA (US)

(72) Inventors: Imad Maurice Jureidini, Arlington, MA (US); Maurice Bennett Shore, Carlisle, MA (US); William Frederick Kiefer, III, Cambridge, MA (US); Sami Mohammed Shalabi, Winchester, MA (US); Cassandra Lynn Doll, Santa Clara, CA (US)

(73) Assignee: Google Inc., Mountain View, CA (US)

(21) Appl. No.: 13/312,643

(22) Filed: Dec. 6, 2011

(51) Int. Cl. G06F 17/00

(52) U.S. Cl. 715/234

(57) ABSTRACT

A system, computer-implemented method and computer-readable medium for displaying edition content of a magazine edition are provided. In a method embodiment, a virtual pixel space is generated based on the configuration of a screen of a mobile device. Data structures that include the edition content in a plurality of items, and a template associated with the magazine edition are received. Display elements in the HTML document are generated by replacing the references from the template with corresponding portions of the edition content included in the items in the data structures. The edition content is generated, based on the display elements of the HTML document, on the virtual pixel space as to be rendered on the screen of the mobile device in the magazine edition.

### BACKGROUND

Users gain access to media content via the Internet or the World Wide Web (or simply the “Web”) using websites. In one example, users enter a website address on their mobile devices to access media content. In another example, users may download an application provided by a particular content provider onto their mobile device. The application then presents a user with a media content that is periodically uploaded to the application from a content source provided by the content provider. However, the design, presentation, and publication of a media content application can be time consuming and arduous.

Moreover, because computing devices have unique specifications that include different operating platforms, a content provider needs to tailor each application to fit the processing requirements of a particular mobile device. As a result, a content provider needs to develop and maintain multiple applications that perform the same function, so that their content can reach as many users as possible.

### BRIEF SUMMARY

A system, computer-implemented method and computer-readable medium for displaying edition content of a magazine edition are provided. In a method embodiment, a virtual pixel space is generated based on the configuration of a screen of a mobile device. Data structures that include the edition content in a plurality of items, and a template associated with the magazine edition are received. Display elements in the HTML document are generated by replacing the references from the template with corresponding portions of the edition content included in the items in the data structures. The edition content is generated, based on the display elements of the HTML document, on the virtual pixel space as to be rendered on the screen of the mobile device in the magazine edition.

Further embodiments, features, and advantages of various embodiments, as well as the structure and operation of the various embodiments are described in detail below with reference to the accompanying drawings.

### BRIEF DESCRIPTION OF THE DRAWINGS/FIGURES

The accompanying drawings, which are incorporated herein and form a part of the specification, illustrate embodiments and, together with the description, further serve to explain the principles and to enable a person skilled in the relevant art to make and use the embodiments.

FIG. 1A is a block diagram of a distributed system environment, according to an embodiment.

FIG. 1B is a block diagram of components in distributed system 100 that generate and distribute magazine editions, according to an embodiment.

FIG. 1C is a block diagram that describes an exemplary communication interfaces between the components within the distributed system, according to an embodiment.

FIG. 2A is a block diagram of a system for displaying edition content of a magazine edition, according to an embodiment.

FIG. 2B is a block diagram of an exemplary data structure.

FIG. 3 is a flowchart of a method for integrating templates with edition content, according to another embodiment.

FIG. 4 is a flowchart of a method for displaying edition content of a magazine edition, according to an embodiment.

FIG. 5 is a flowchart of a method for laying out edition content of a magazine edition, according to another embodiment.

FIG. 6 is a block diagram of a computer system in which embodiments can be implemented.

Example embodiments will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF EMBODIMENTS

The following detailed description refers to the accompanying drawings that illustrate exemplary embodiments of what is claimed herein. The detailed description is not meant to be limiting. Other embodiments are possible, and modifications can be made to the embodiments within the spirit and scope of what is described herein.

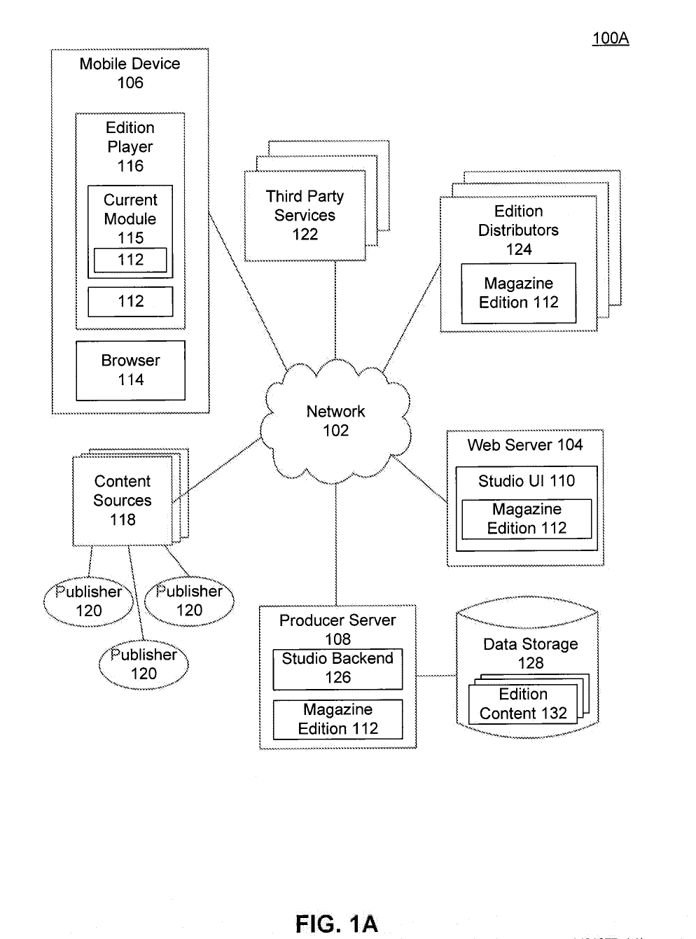

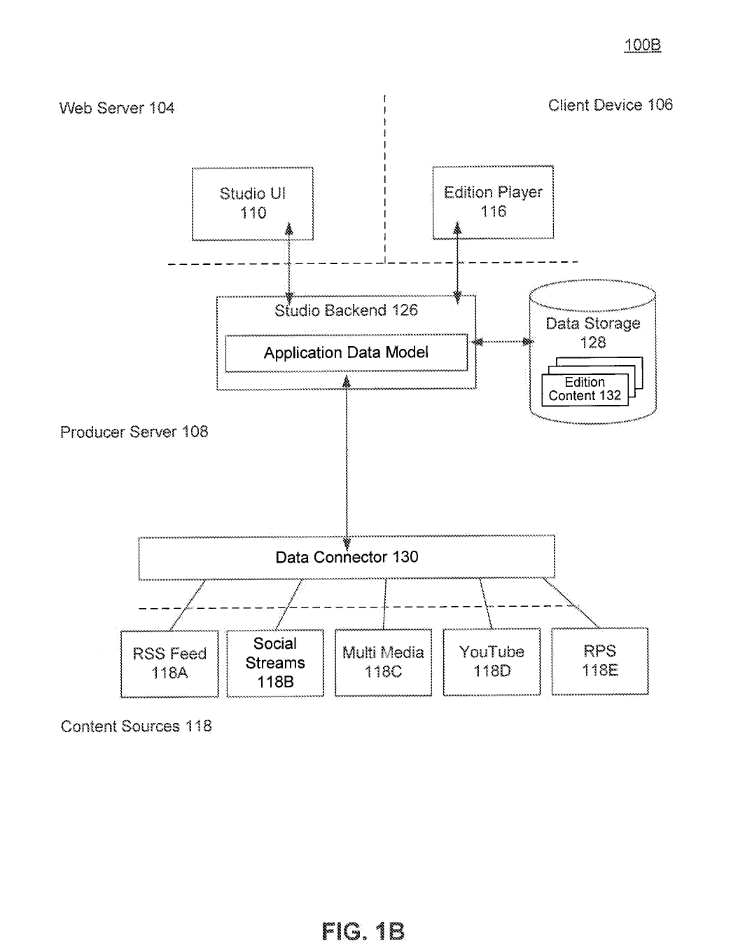

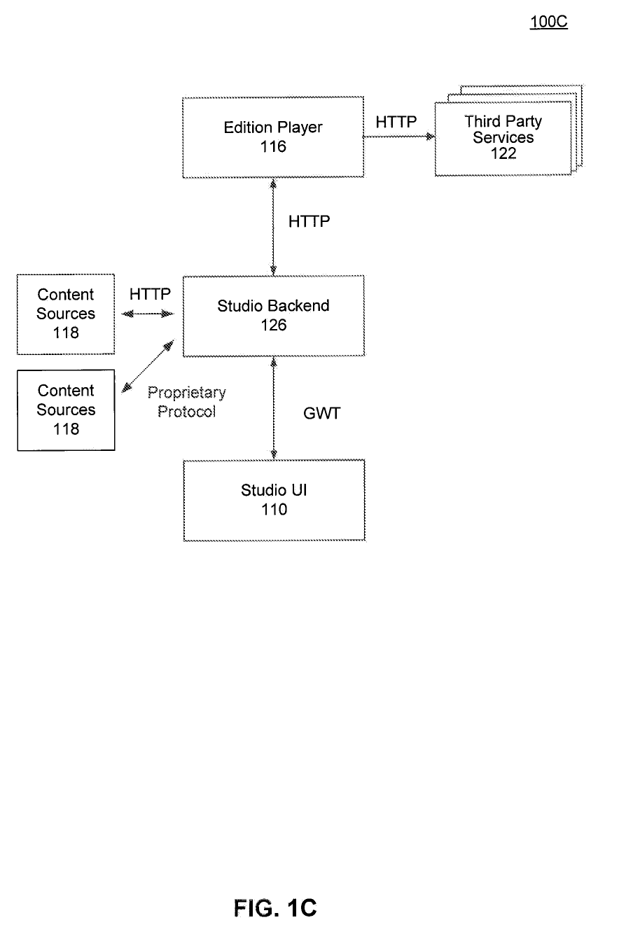

FIG. 1A is a block diagram 100A of a distributed system environment. Distributed system environment 100A includes one or more networks 102, web servers 104, producer servers 108 and mobile devices 106.

Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

Web server 104 is a computing device or an application executing on a computing device that hosts multiple websites. A website is one or more resources associated with a domain name and hosted by one or more web servers 104. An example website is a collection of webpages formatted in hypertext markup language (HTML) that can contain text, images, multimedia content, and programming elements, such as scripts. Web server 104 hosts studio user interface (“UI”) 110. Studio UI 110 enables users, such as publishers 120, to design interactive magazine editions 112 that may be distributed to multiple mobile devices 106. Publisher 120 may access studio UI 110 using a web address that is hosted on web server 104. Once accessed, publisher 120 may use studio UI 110 to design the layout of magazine edition 112 and configure content sources 118 for mobile devices 106 having different specifications.

In another embodiment, publisher 120 may download studio UI 110 onto a mobile device 106 as a standalone application or as a plugin or extension to a browser.

Magazine edition 112 may be designed using studio UI 110. Magazine edition 112 displays edition content to users in, for example, a format specified by publishers 120. However, unlike conventional applications that include a separate version for each mobile device having a particular operating platform, edition content displayed using magazine editions 112 may be displayed on mobile devices 106 in a format that is specified by a particular publisher, regardless of the native operating platform particular to mobile device 106. Magazine editions 112 may also layout edition content according to the size of a display screen of mobile device 106.

Mobile device 106 is an electronic device that is under the control of a user and is capable of requesting and receiving resources over network 102. Example mobile devices 106 are mobile communication devices such as smart phones and tablet computers. Mobile device 106 typically includes an application, such as a web browser (or simply browser) 114. A user controls browser 114 to request resources over network 102. A user requests a resource by typing the website address associated with the resources that is stored on web server 104. For example, a user, such as publisher 120 may use browser 114 to access studio UI 110 to design an interactive magazine edition using mobile device 106.

Mobile device 106 also includes edition player 116. Edition player 116 displays magazine editions 112 to users. Magazine edition 112 displays dynamic media content on mobile devices 106, where mobile devices have different specifications and display screen size. Edition content included in magazine editions 112 includes content downloaded to magazine editions 112 using content sources 118. To display magazine editions 112, edition player 116 may use a current module 115 or display edition content using edition player 116.

Current module 115 stores magazine editions 112 which are published by publisher 120. Current module 115 may be downloaded to mobile device 106 from, for example, producer server 108 using network 102 or using another interface. Typically, once current module 115 is downloaded to mobile device 106, a user uses current module 115 to subscribe to magazine editions 112. Once subscribed, current module 115 uses mobile device 106 to download magazine editions 112 from producer server 108, or edition distributor 124. Current module 115 also updates magazine edition 112 with new edition content. In an embodiment, current module 115 also provides a user with a listing of recommended magazine editions 112 that may be of interest to the user and that a user may subscribe to.

Producer server 108 includes studio backend 126. Studio backend 126 allows for a design, development and implementation of magazine editions 112. Studio backend 126 communicates with studio UI 110 when publisher 120 uses studio UI 110 to design magazine edition 112.

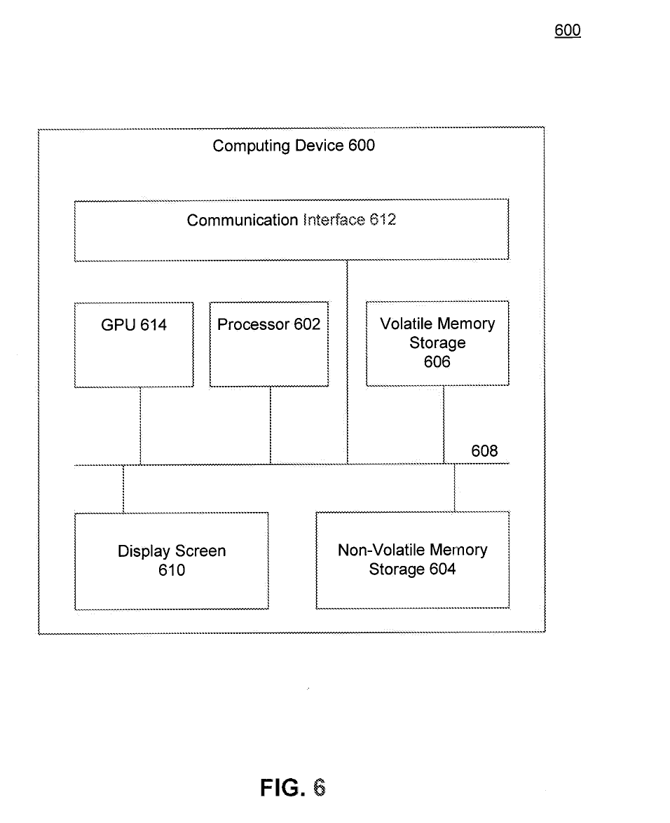

Once publisher 120 completes designing magazine edition 112 using studio UI 110, magazine edition 112 is uploaded to producer server 108 for storage and distribution. In an embodiment, magazine editions 112 may be stored on producer server 108 in a memory storage described in detail in FIG. 6. In another embodiment, publisher 120 may upload magazine edition 112 to edition distributors 124. A user may access edition distributor 124 and download magazine edition 112 to mobile device 106. In an embodiment, once publisher 120 decides to distribute an upgraded magazine edition 112, mobile devices 106 that include a previous version of magazine edition 112 are synchronized with the upgraded magazine edition 112.

Content sources 118 provide edition content 132 to magazine edition 112. Example content sources 118 include data feeds, RSS feeds, social streams, user-generated media sources, multi-media sources via media RSS, etc. Content source 118 is typically associated with a publisher 120. Publisher 120 owns a particular content source 118 and controls edition content 132 that is distributed via content sources 118 over network 102.

Producer server 108 receives edition content 132 from content sources 118. Once received, producer server 108 stores edition content 132 in data storage 128. Data storage 128 may be a memory storage described in detail in FIG. 6. In an embodiment, data storage 128 may include a database for storing edition content 132. When magazine edition 112 executing on edition player 116 requests edition content 132, producer server 108 retrieves edition content 132 from data storage 128 and transmits edition content 132 to edition player 116.

Third party services 122 provide services to magazine editions 112. For example, third party services 122 provide streaming video that may be accessed by a uniform resource locator (“URL”) link included in magazine edition 112. In another example, third party services 122 determine that a user read a particular article included in magazine edition 112. In another example, third party services 122 provide advertisements for display within magazine edition 112. In another example, third party services 122 provide check out services for merchandise items that are provided for purchase within magazine edition 112.

Edition distributors 124 distribute applications, such as magazine editions 112 to mobile devices 106. For example, when publisher 120 designs magazine edition 112, publisher 120 may elect a particular edition distributor 124 to distribute magazine edition 112. When publisher 120 elects to distribute magazine edition 112 using a particular edition distributor 124, magazine edition 112 is uploaded to edition distributor 124. A user may then use mobile device 106 to access edition distributor 124 and upload magazine edition 112 onto mobile device 106 for an agreed upon fee.

FIG. 1B is a block diagram 100B of components in distributed system 100 that generate and distribute magazine editions.

As described herein content sources 118 provide edition content 132 that is distributed across the web via network 102. For the edition content 132 to be distributed using magazine editions 112, content sources 118 are connected to producer server 108. In an embodiment, data connector 130 connects multiple content sources 118 and retrieves edition content 132.

Data connector 130 receives data from content sources 118. Data connector 130 may receive edition content 132 from content sources 118 in real-time or at configurable intervals that may be set by a system administrator. Once data connector 130 receives edition content 132 from content sources 118, data connector 130 transmits edition content 132 to data storage 128.

As described herein, data storage 128 distributes data from content sources 118 to magazine editions 112. For example, mobile device 106 may request data for particular magazine editions 112 at configurable time intervals that may be configured by the user subscribing to magazine editions 112.

Studio backend 126 receives the designed magazine editions 112 from studio UI 110. As described herein, studio UI 110 allows publishers 120 to design dynamic and interactive magazine editions that display edition content 132 provided by their content sources 118. Once publisher 120 completes designing magazine edition 112, publisher 120 uploads magazine edition 112 to studio backend 126. Studio backend 126 then stores the uploaded magazine editions 112 on producer server 108 and/or distributes magazine editions 112 to mobile devices 106 or edition distributors 124.

Studio backend 126 includes application data model 134. Application data model 134 includes a format that displays edition content 132 within magazine editions 112. When publisher 120 uses studio UI 110 to create a particular magazine edition 112, studio UI 110 presents publisher 120 with application data model 134 framework that publisher 120 may configure to include edition content 132 for presentation to a user.

Upon a user request from mobile device 106, studio backend 126 may distribute magazine editions 112 to mobile devices 106. Each magazine edition 112 includes application data model 134 that is configured by publisher 120.

When magazine edition 112 is uploaded to mobile device 106, magazine edition 112 is populated with edition content 132. For example, producer server 108 provides edition content 132 from data storage 128 to magazine edition 112. As edition content 132 is updated with new edition content 132 from content sources 118, producer server 108 synchronizes edition content 132 included in magazine edition 112 with the new edition content 132 that is included in data storage 128.

In an embodiment, the synchronization may occur at configurable time intervals that may be configured by a user using mobile device 106. For example, a user may configure magazine edition 112 to query data storage 128 for new content every hour, every twelve hours, once a day, when requested by a user, etc. In a further embodiment, magazine edition 112 receives edition content 132 from data storage 128 that has been updated since the previous synchronization period, as to minimize the transmission of data over network 102.

FIG. 1C is a block diagram 1000 that describes an exemplary communication interface between the components within the distributed system.

For example, edition player 116 may communicate with studio backend 126 using HTTP over network 102. Edition player 116 may also communicate to third party services 122 and edition distributors 124 using HTTP.

Studio UI 110 may communicate with studio backend 126 using a Google Web Toolkit (“GWT”) infrastructure. A person skilled in the art will appreciate that GWT allows web application developers to design JavaScript front-end applications using Java source code. In an embodiment GWT uses protocol buffers, also known to a person of ordinary skilled in that art, to pass data that includes magazine editions 112, templates, edition content 132, etc., between studio UI 110 and studio backend 126.

Studio backend 126 also communicates with a variety of content sources 118. In one embodiment, studio backend 126 may be configured to communicate with content sources 118 using a proprietary communication protocol that is specified by a particular content source 118. In another embodiment, studio backend 126 may also communicate with content sources 118 using HTTP.

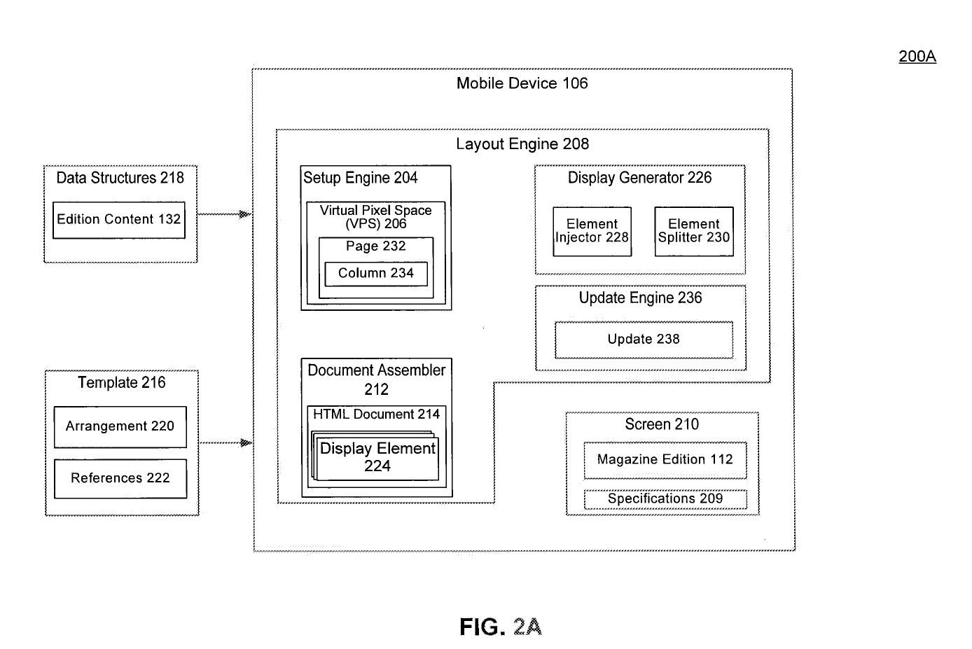

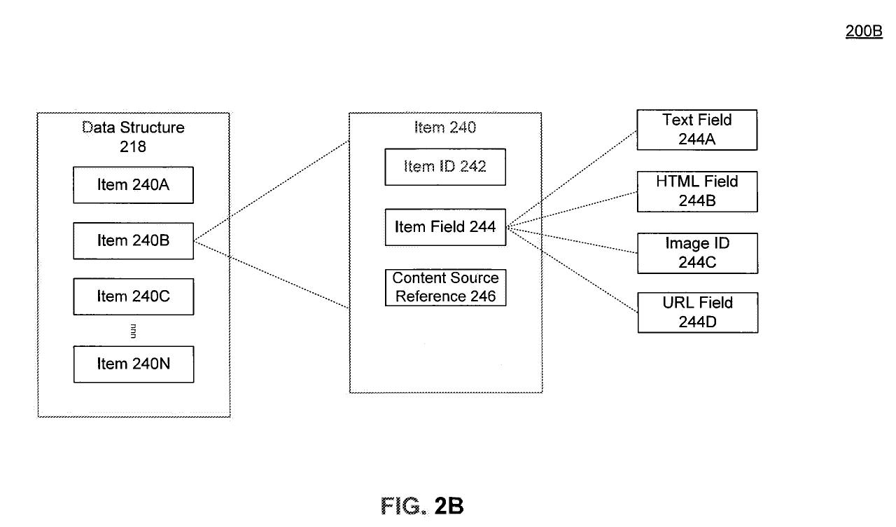

FIG. 2A is a block diagram of a system 200A for displaying edition content of a magazine edition, according to an exemplary embodiment. System 200A provides templates for displaying edition content 132 across different devices. System 200A allows for a single template 216 or layout file, to be distributed across multiple mobile devices 106 having different specifications for rendering edition content 132. Each device may be provided the same template 216, and may render the appropriate layout of edition content 132 for the particular screen 210 of the device.

System 200 also allows for the edition content 132 to be modified independently of template 216. For example, if either edition content 132 or template 216 is modified or updated, system 200 allows for local binding of template 216 with edition content 132. For local binding to occur, only the updated templates 216 or edition content 132 need to be provided to system 200 to render the updated magazine edition 112 on screen 210.

Layout engine 208 formats edition content 132 for display on mobile devices 106 having different specifications or configurations. Layout engine 208 receives edition content 132, using, for example, an HTML stream and generates a single or multi-column layout of edition content 132 that is appropriate for the size and orientation of a screen 210 of mobile device 106.

A setup engine 204 may generate a virtual pixel space 206 for mobile device 106.

Virtual pixel space (VPS) 206, hereinafter referred to as VPS 206, may be a canvas upon which edition content 132 is rendered. Setup engine 204 may generate VPS 206 based on specifications 209 of screen 210, as configured by mobile device 106 provider.

Mobile device 106 may include screen 210 upon which edition content 132 is rendered. Different mobile devices 106 may have different screens 210, each of which may have a different specifications 209. Example specifications 209 may include size, shape, pixel density and orientation of the screen 210. The screens 210 of a laptop, mobile phone and tablet PC may each have different specifications 209 for their respective screens 210. For example, a tablet PC may have a larger screen 210 than a smartphone. Or, for example, two different models of mobile phones may have different dimensions and pixel densities. Or, for example, a mobile device 106 may be operated in either a portrait orientation (in which the height of the screen 210 is greater than its width) or landscape orientation (in which the width of screen 210 is greater than its height). Setup engine 204 may determine these specifications 209, by, for example, querying the operating system on mobile device 106 and generate virtual pixel space 206.

In an example embodiment, setup engine 204 generates VPS 206 of particular size based on the dimensions of screen 210. Or for example, over time, specifications 209 may change (e.g., if mobile device 106 is toggled between operating with a portrait orientation or landscape orientation), in which case setup engine 204 may update VPS 206 appropriately. VPS 206 may include multiple pages 232 upon which magazine edition 112 is generated for display. As will be discussed in greater detail below, each page 232 of VPS 206 may include one or columns 234.

A document assembler 212 may generate an HTML document 214 for rendering edition content 132 using VPS 206. Document assembler 212 may generate HTML document 214 by binding edition content 132 from data structures 218 with a template 216.

Edition content 132 may be provided via data structures 218 which may include any storage, memory or format in which to store edition content 132. Edition content 132 may include text, images, files, videos, streams (including live streams) or other data that may be displayed on mobile device 106.

Data structure 218 stores edition content 132 received or collected from content sources 118. Data structure 218 is a computer structure that stores and organizes information, and may be included for example in an HMTL or XML document, or defined using a programming language such as, in a non-limiting embodiment, Java or JavaScript. The information in data structure 218 may be stored or retrieved using an interface that is defined by an application developer or is particular to a programming language.

In one embodiment, data structure 218 includes multiple items. Each item stores edition content 132 or a portion of edition content 132 of a particular type. Example item types may include plain-text, HTML, images, video, unified resource locators (URLs), audio files, plain-text files, geographic locations, etc.

Each item includes an item identifier and multiple item fields. An item identifier identifies a particular item in data structures 218. Each item field within the item is specific to a type of the item. For example, an item that stores plain text data may have a text field and an item that includes HTML data includes an HTML field. In another example, an item that includes image data has an image ID field, where the image ID field stores a memory address to the location of the image. In another example, an item that accesses a video, includes a URL field to a location of the video in, for example, content source 118 or data storage 128. A person skilled in the art will appreciate that the examples above are given by way of example, and not limitation, and that data structure 218 may include of types of items that store or access other types of data.

In an example embodiment, publisher 120 may assign edition content 132 to data structures 218. When publisher 120 builds magazine edition 112 using studio UI 110, publisher 120 configures edition content 132 into categories within application data model 134. Application data model 134 may include multiple subscriptions to one or more content sources 118 from which a user subscribes to receive edition content 132 within magazine edition 112. A user may wish to subscribe to his own content source 118 when a user publishes content source 118 or may wish to subscribe to a third party's (e.g. publisher's 120) content source 118. In application data model 134, edition content 132 from the content sources 118 may be packaged together as data structures 218.

FIG. 2B is a block diagram 200B of an exemplary data structure. Data structure 218 includes multiple items 240. Example items 240 are items 240A-N in FIG. 2B. Items 240 may have various item types. Example item types may include plain-text, HTML, images, video, URLs, audio, locations (such as a web address), etc., that are provided as edition content 132. Each item 240 includes an item identifier 242 that identifies a particular item 240. Item 240 also includes multiple item fields 244 that are specific to a type of item 240. For example, item 240 that includes plain text data may have a text field 244, item 240 that includes HTML data includes an HTML field 244B, item 240 that includes image data has an image ID field 244C that stores a location to an image in data storage 128, item 240 that includes a video includes a URL field 244D to a location of a video, etc.

Item 240 may also include a content source reference 246. Content source reference 246 includes a link to content source 118 that provided edition content 132 included in data structure 218. When displaying edition content 132 in magazine edition 112, a user may access and activate the content source references 246 to obtain access to additional content.

Going back to FIG. 2A, template 216 defines the arrangement 220 or layout for rendering edition content 132 that is stored as data structures 218. Template 216 may be a native template that is optimized for executing on mobile device 106 and may use core mobile device runtime libraries. Template 216 may also be a custom template designed by publisher 120 that format edition content 132 on screen 210 as designed by publisher 120. Publisher 120 may provide template 216 to layout various portions of magazine edition 112. For example, different templates 216 are provided to layout sections, table of contents, posts (that include articles or videos), etc., of magazine edition 112.

In an example embodiment, template 216 may include a document written in a code, such as HTML, for which objects of template 216 are rendered uniformly across similar devices 106. Template 216 may include special tags that may be extensions of HTML or another computing language used to construct template 216. These special tags may allow template 216 to include information for various mobile devices 106 upon which magazine edition 112 is to be viewed. For example, template 216 may have a conditional content tag that allows a publisher 120 to specify which edition content 132 is to be displayed on a particular mobile device 106 and how that edition content 132 is to be rendered. More particularly, the special tags may allow publisher 120 to specify (using template 216) how to display edition content 132 for magazine edition 112 on a phone versus a tablet computer, or in portrait orientation versus landscape orientation.

Other example special tags that may be included in template 216 include tags allowing for links between posts or sections of magazine edition 112, merchandize items or shopping cart tags, tags that allow a user or reader of magazine edition 112 to create content associated with magazine edition 112, loops that may be executed when rendering template 216. The loops may allow for an entire section of template 216 to be evaluated in order to determine which edition content 132 to render and/or how to render it for magazine edition 112.

Template 216 may include arrangement 220 of how edition content 132 is to be laid out or organized for magazine edition 112, and references 222 for which edition content 132 corresponds to the layout. References 222 may include pointers or placeholders, identifying which portion(s) of edition content 132 in data structure 218 that is included in magazine edition 112. For example, a reference 222 may correspond to an item 240 (of FIG. 2B), such as a particular image to be included in an article of magazine edition 112. Or, for example, a reference 222 may correspond to a group of items 240 without necessarily referring to individual items 240. In an example usage, reference 222 may be to all the images of magazine edition 112 as stored in items 240, which may then be organized into a slideshow. Or, in a non-limiting example, specific filters may be applied to reference particular groups of items 240, such as videos with lengths greater than five minutes.

In an embodiment, arrangement 220 includes a layout of text and image boxes for a particular page of magazine edition 112, and references 222 include pointers or other descriptions identifying items 240 in data structure 218 that correspond to the boxes of arrangement 220. Or, for example, arrangement 220 may include an order of different posts as they are to appear in magazine edition 112.

In an example embodiment, template 216 includes arrangements 220 for multiple computing devices. Publisher 120 may define particular arrangements 220 for particular mobile devices 106 having specifications 209. For example, a publisher 120 may choose to include an article in edition content 132 with an image when the article is displayed on tablet computers, but may choose to leave out the image when the article is displayed on mobile phones or other devices with a screen size smaller than a configurable, predefined size. As referenced above, such arrangements 220 may be included in template 216 using the special tags, and may have outcomes which are determined based on the values of specifications 209.

References 222 may be tags or addresses that identify, to document assembler 212, which edition content 132 corresponds to template 216. References 222 may include addresses identifying where edition content 132 is stored. In an example embodiment, references 222 may include an extension to HTML. The extensions may include tags that are compatible with HTML 5 or later, and may be used in HTML document 214 to identify edition content 132.

Document assembler 212 may bind data structures 218 with template 216. For example, document assembler 212 may replace references 222 from template 216 with the corresponding edition content 132 from data structures 218 to generate display elements 224 of HTML document 214.

HTML document 214 may include a structured document that includes both arrangement 220 and corresponding edition content 132 information as series of display elements 224. Display elements 224 may include instructions (e.g., HTML code) on how to arrange particular data. Each display element 224 may include HTML tags, including extensions of HTML thereof, and/or edition content 132 for display. HTML document 214 may allow for a single document to be used to render magazine edition 112 on mobile device 106.

HTML document 214 may be organized as a stack in an embodiment. A stack may be a data structure for which components are processed in either a first-in, first-out (FIFO) or a last-in, first-out (LIFO) manner. For example, in HTML document 214, the first or topmost display element 224 of HTML document 214 may be the first element processed by display generator 226. Display generator 226 may then continue processing with the next display element 224 until the end of HTML document 214, or bottom of the stack has been reached.

In an embodiment, document assembler 212 may only include those portions of template 216 and data structures 218 that are relevant for mobile device 106. For example, arrangement 220 may include both particular layout features for edition content 132 on a laptop computer and a tablet computer. Then, for example, if mobile device 106 is a tablet computer, document assembler 212 may only include those portions of template 216 and edition content 132 as applied to tablet computers.

Document assembler 212, executing on mobile device 106, may allow for updates to edition content 132 or template 216 to be performed independently of one another. For example, layout engine 208 may receive data structures 218 separately (e.g., in a separate file or files) from template 216. Document assembler 212 may then perform a local binding between template 216 and data structures 218 to HTML document 214, as discussed above.

This local binding may allow a publisher 120 to update arrangement 220 without updating data structures 218, and provide only the updated templates 216 to mobile device 106, allowing mobile device 106 to render magazine edition 112 of the updated templates 216 using the original data structures 218. Local binding may also allow publisher 120 to update edition content 132 without updating templates 216, and provide only the updated data structures 218 to mobile device 106, allowing mobile device 106 to render magazine edition 112 with the updated edition content 132 using the original templates 216.

Or, for example, when publisher 120 changes a portion of the edition content 132 (e.g., an image or article displayed in magazine edition 112), then only the data structure 218 for the changed image needs to be provided to replace the old or previous image, with the new image. In such a case, the existing template 216 may remain the same. Document assembler 216 may then update HTML document 214 to include the new image as retrieved from the new data structure as an updated display element 224 when a user accesses the article or image in magazine edition 112.

Display generator 226 may generate magazine edition 112 from display elements 224 of HTML document 214. Display generator 226 may include an element injector 228 and an element splitter 230. Element injector 228 may retrieve a display element 224 from HTML document 214 and may generate it on VPS 206. Element splitter 230 may divide, split or otherwise partition a display element 224 into two or more portions to fit into the available space remaining on a particular page 232 or column 234 of VPS 206, when the display element 224 is divisible.

As referenced above, VPS 206 may include a number of pages 232, and each page may include one or more columns 234. The number of pages 232 and the number of columns 234 of VPS 206 for a particular magazine edition 112 may vary depending on specifications 209 of screen 210. For example, larger screens 210 may be able to display more edition content 132, and thus may have more columns 234 and fewer pages 232. Setup engine 204 may divide VPS 206 into a number of columns 234 as determined based on screen specifications 209. In an example embodiment, a VPS 206 for mobile devices 106 such as a laptop computer may have three columns 234, a tablet computer may have two columns 234, and a smartphone may only have one column 234.

In an embodiment, HTML document 214 may be organized as a stack of display elements 224. Display generator 226 may then read the stack and process the display elements 224 in the order in which they are organized. For each display element 224 corresponding to a rendering of edition content 132 on VPS 206, element injector 228 may render the display element 224 in a column 234 of VPS 206. Element injector 228 may start at the top of a column 234 and continue filling display elements 224 into the available space of the column 234 until the column 234 is full.

If a particular display element 224 does not fit into the available space of a column 234, then element splitter 230 may determine if the particular display element 224 is divisible. Certain display elements 224 may be divisible into multiple portions, such that a first portion may be displayed in a first column 234 and a second portion may be displayed in a second column 234 (which may be on a different page 232). For example text may be divisible into any number portions of different sizes, while an image or a video may not be divisible, or may be resized into portions of a certain size.

If the display element 224 is divisible into small enough portions such that the first portion fits into the available space of a column 234, then element splitter 230 may render the first portion in the available space of the first column 234, and the remainder in a second column 234. If however, the display element 224 is not divisible, or the portions cannot fit into the available space of a column 234, then the element splitter 230 may render the display element 224 onto the next empty column 234. The remaining available space from the previous column 234 may then be filled in with a different display element 224 or an advertisement.

In an example embodiment, an advertisement module (not shown) may insert advertisements into edition content 132 displayed by magazine edition 112. This feature allows publisher 120 to monetize on the displayed magazine edition 112 by providing advertisements to a user. The advertisement module may determine where and when to include advertisements within magazine edition 112. For example, when display generator 226 determines that a column 234 has available space that cannot be or is not filled by edition content 132, the advertisement module may query an advertisement system to select an advertisement for inclusion in the available space. This query and advertisement injection may be performed in real-time (i.e., be performed as magazine edition 112 is rendered on screen 210), or may be performed prior to a user requesting to view the particular page 232 where advertisement exists. The advertisement module may communicate with various advertising entities that provide advertisement module with advertisements for display within magazine edition 112. Then for example, display generator 226 may select, or the advertisement module may otherwise provide, one or more of the advertisements to include in the available space of magazine edition 112. In an embodiment, advertisement module may determine a location of mobile device 106 or preferences of a user, and query the advertisement system for advertisements based on the location or user preferences.

Display generator 226 may then repeat the processes of element injector 228 and element splitter 230 for all of the display elements 224 of HTML document 214 until the end of HTML document 214 is reached. When the last column 234 of a particular page 232 of VPS 206 is filled, then setup engine 204 may create a new page 232 with the same column format as the previous page 232 for screen 210. The display generator 226 may also fill the remaining space on the last page 232 with an advertisement. Magazine edition 112 may then be rendered on screen 210. When a user views magazine edition 112 on screen 210, the user may be provided the first page 232 of VPS 206, with whatever edition content 132 is rendered thereon.

An update engine 236 may receive an update 238 to magazine edition 112.

Update 238, as referenced above may include updates to template 216 and/or data structures 218. As referenced above, when template 216 or data structures 218 are updated, only those files that are updated may be received in update 238. Document assembler 212 may then generate an updated HTML document 214, which may be rendered by display generator 226.

In another example embodiment, update 238 may include an update to specifications 209. For example, when a user is operating mobile device 106 in a portrait orientation, and then begins operating mobile device 106 in a landscape orientation (e.g., perhaps by turning the mobile device 106), update 238 may be received for specifications 209. This change may cause specifications 209 to be updated, and for update engine 236 to register that an update 238 has occurred. Or, for example, display generator 226 may query mobile device 106 to determine specifications 209 prior to rendering magazine edition 112 on VPS 206. As such, based on the query, display generator 226 may render the appropriate edition content 132 on a VPS 206 configured for portrait or landscape orientation, as determined from mobile device 106.

System 200, using the same template 216 and data structures 218, may allow magazine edition 112 to be rendered to fit specifications 209 of a screen 210 of mobile device 106. The use of the same template 216 and data structures 218 may allow a publisher 120 to only figure template 216 and data structures 218 once, and provide those files to mobile devices 106, upon which system 200 may select the relevant portions to be displayed. This may allow publisher 120 to focus efforts on generating edition content 132 and create templates 216 on how the magazine editions 112 should appear, without having to perform special modifications for each possible set of mobile devices 106 having specifications 209. System 200 may further divide the screen 210 into multiple columns 234, for unique, device-specific rendering capabilities.

In an example embodiment, layout engine 208 may be included on or as part of studio UI 110. As part of studio UI 110, layout engine 208 may allow publisher 120 to preview the display of edition content 132 on templates 216 prior to distributing magazine editions 112 to mobile devices 106. For example, rather than querying a particular mobile device 106 for specifications 209, studio UI 110 may be configured to approximate known specifications for a number of mobile devices 106. Then for example, while operating studio UI 110, publisher 120 may view a preview of sections and posts in magazine edition 112. The preview may be an approximation of how magazine editions 112 will be displayed on mobile devices 106 after magazine edition 112 is distributed to users. Moreover, layout engine 208 in studio UI 110 allows publisher to select a preview of edition content 132 on mobile device in portrait and landscape orientation.

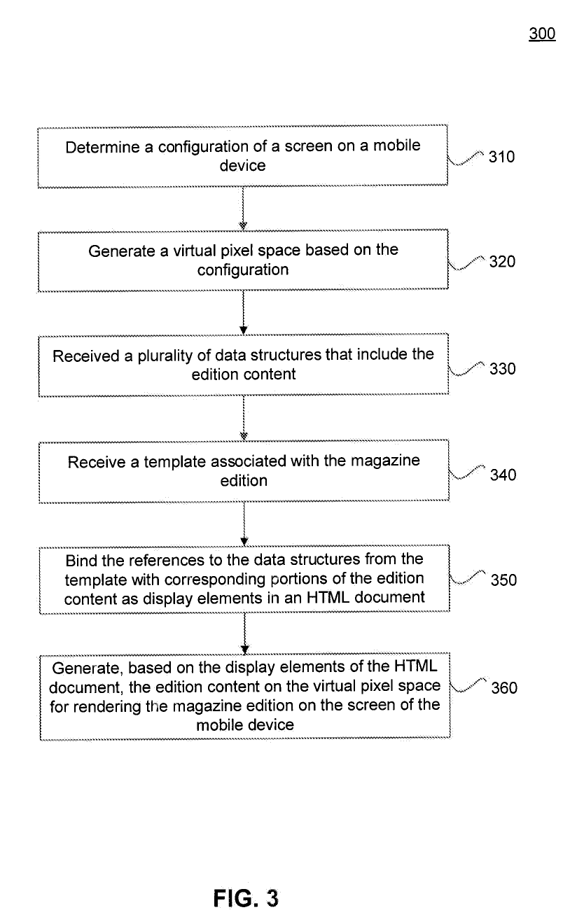

FIG. 3 is a flowchart of a method 300 for integrating templates with edition content, according to an example embodiment. At stage 310, a configuration of a screen on a mobile device is determined. For example, setup engine 204 may query specifications 209 of screen 210 for mobile device 106. Specifications 209 may include features such as device model, screen dimensions, pixel density and orientation.

At stage 320, a virtual pixel space is generated based on the configuration. For example, setup engine 204 may generate VPS 206 based on specifications 209. VPS 206 may include dimensions corresponding to, or otherwise based on the dimensions of screen 210. In an example embodiment, setup engine 204 may generate two or more VPS 206 corresponding to how mobile device 106 may be operated. For example, if mobile device 106 may be operated in either a portrait or landscape orientation, then a VPS 206 may be generated for each orientation. VPS 206 may be divided into a number of columns 234 in which to render edition content 132.

At stage 330, a plurality of data structures that include the edition content are received. For example, mobile device 106 may receive data structures 218 that may include edition content 132. Edition content 132 may include any content or data that may be rendered on mobile device 106, including textual content, image content, video content, and other multi-media content.

At stage 340, a template associated with the magazine edition is received. For example, template 216 may be received at mobile device 106. Template 216 may include arrangement 220 of the edition content 132 as it is to be displayed in VPS 206. Template 216 may also include references 222 to the edition content 132 stored in data structures 218 that is to be rendered. In an example embodiment, templates 216 may exist for all pages 232 of magazine edition 132, for a particular grouping or section of pages 232 of magazine edition 112, for a particular page 232, or on an article/edition content 132 basis. For example, a magazine edition 112 may include a sports section, in which all the edition content 132 uses the same template 216. The sports section may also however include a featured article, the edition content 132 for which has its own unique template 216 which may differ from the template 216 for the remainder of the sports section.

At stage 350, the references to the data structures from the template are bound to corresponding portions of the edition content as display elements in an HTML document. Document assembler 212 may replace references 222 from template 216 with the corresponding edition content 132 from data structures 218 to generate display elements 224. For example, document assembler 212 may identify references 222 within template 216. For each reference 222, document assembler 212 may retrieve the corresponding edition content 132 from data structures 218. Document assembler 212 may then replace a reference 222 with its corresponding edition content 132 to generate a display element 224. The generated display element 224 may then be added to HTML document 214.

At stage 360, based on the display elements of the HTML document, the edition content is generated on the virtual pixel space for rendering the magazine edition on the screen of the mobile device. For example, mobile device 106 may render VPS 206 on screen 210. This may allow a user of mobile device 106 to view magazine edition 112 on screen 210.

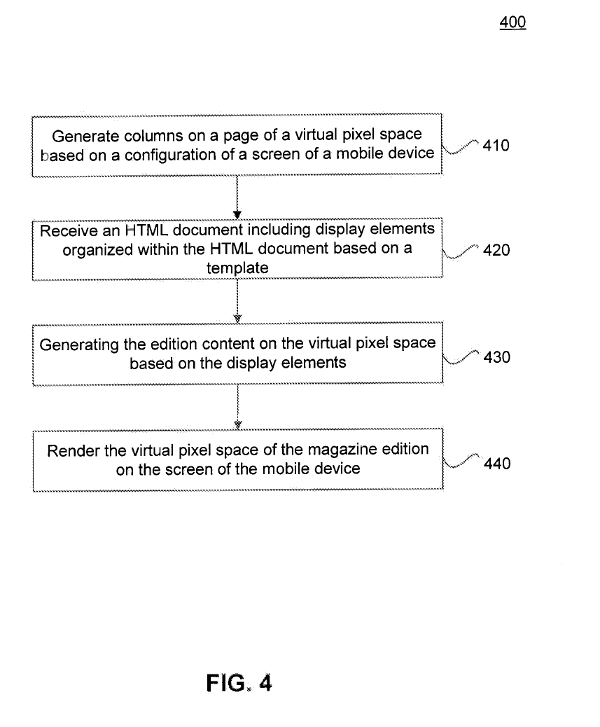

FIG. 4 is a flowchart of a method 400 for displaying edition content in a magazine edition, according to an example embodiment. At stage 410, columns are generated on a page of a virtual pixel spaced based on a configuration of a screen of a mobile device. For example, setup engine 204 may generate VPS 206, including one or more columns 234. The number of columns 234 on a page 232 may be determined based on specifications 209, such as the dimensions and orientation of screen 210. As display elements 224 are added to columns 234, additional pages 232 (each corresponding to a VPS 206) may be generated by setup engine 204.

At stage 420, an HTML document including display elements organized based on a template is received. For example, mobile device 106 may receive HTML document 214 from document assembler 212 that may be operating on another device or server, such a cloud computing device where data for mobile device 106 may be stored. HTML document 214 may then include display elements 224, as discussed above, particular to specifications 209, which may be displayed on VPS 206.

At stage 430, the edition content is generated on the virtual pixel space based on the display elements of the HTML document. For example, display generator 226 may retrieve display elements 224 from the top of a stack in which HTML document 214 is organized. Then element injector 228 and element splitter 230 may arrange the display elements 224 on the columns 234 and pages 232 of VPS 206 as discussed above.

In another example embodiment, display generator 226 may determine which display elements 224 to generate based on an availability of space on existing columns 234 and pages 232. For example, after a number of display elements 224 are selected from HTML document 214 and generated on various columns 234 and pages 232 of magazine edition 112, there may be available space existing amongst the columns 234 or pages 232. Then, for example, display generator 226 may search HTML document 214 for display elements 224 that fit within any of the available space prior to generating new pages 232 upon which to generate subsequent display elements 224. In another example embodiment, any existing available space may be filled with advertisements or other images, such that magazine edition 112 does not include any unintended unused space.

At stage 440, the virtual pixel space of the magazine edition may be rendered on the screen of the mobile device. For example, magazine edition 112 may be rendered on screen 210 based on the arrangement of display elements 224 on VPS 206.

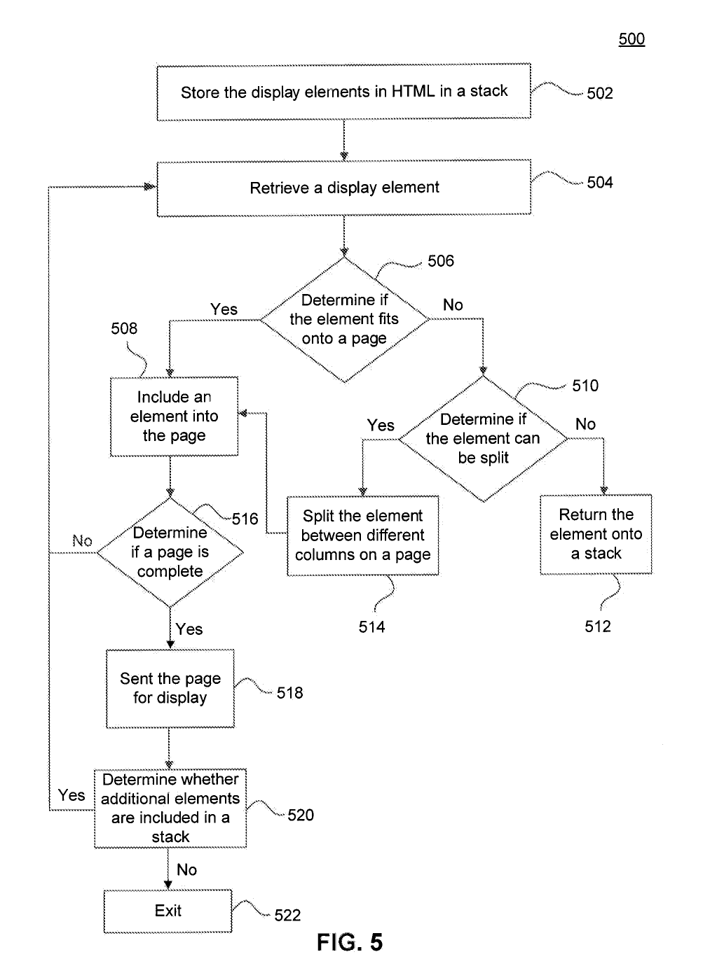

FIG. 5 is a flowchart of a method 50500 for laying out edition content in a magazine edition, according to an example embodiment. At stage 502 display elements are stored in a stack. For example, document assembler 212 may generate HTML document 214, in which display elements 224 are organized into a stack. The stack may be a data structure in which display elements 224 are processed by display generator 226 in first-in, first-out (FIFO) or last-in, first-out (LIFO) manner.

At stage 504, a display element is retrieved. For example, display generator 226 may retrieve a display element 224 from HTML document 214. Display element 224 may include edition content 132 that is to be displayed on VPS 206.

At stage 506, it is determined if the display element fits onto a page. For example, setup engine 204 may generate a page 232 of VPS 206. Each page 232 may include one or more columns 234. In an example embodiment, display generator 226 may determine whether display element 224 fits onto a particular page 232 or a column 234 (if the page 232 is divided into two or more columns 234).

At stage 508, if the display element fits onto the page, the display element is included onto the page. For example, element injector 228 may render display element 224 onto page 232 where edition content 132 of display element 224 fits. Or, for example, if page 222 is divided into two or more columns 234, element injector 228 may generator display element 224 onto a particular one of the columns 234 with available space. In an example embodiment, if page 232 is divided into two or more columns 234 and display element 224 fits onto page 232 but not within column 234, then either columns 234 may be readjusted or removed to fit display element 224, or stage 510 processing may occur with regards to fitting display element 224 in a particular column 234.

At stage 510, when it is determined that an element does not fit onto a page, it is determined if the element can be split. For example, certain display elements 224 may be divisible (such as text, which may be divisible at any number of junctures), while other display elements 224 (such as images or video) may not be divisible (or may have limited divisibility). Element splitter 230 may determine whether or not display elements 224 are divisible. For example, a display element 224 may include an indicator that indicates whether or not it is divisible, where it may be divided and/or into how many portions it may be divided.

At stage 512, when it is determined that the element does not fit onto a page and that the element cannot be split, then the element is returned to the stack. For example, if a display element is not divisible (or is otherwise not divisible into a small enough portion to fit onto a page 232), then the display element 224 is returned to the stack (HTML document 214) and the processing repeats from stage 504 with the next display element 224 from the stack. In an example embodiment, the indivisible display element 224 may also be returned to the stack if it cannot fit within an empty column 234 of a page 232.

At stage 514, when the element is divisible, the element is split between different columns on a page. For example, element splitter 230 may render a first portion of the display element 224 on a first page 232, while a second or remainder portion of the display element 224 may be included on a second or other subsequent pages 232. For example, an article may begin on a first page of magazine edition 112, and be continued on the second page of the magazine edition 112. Or, for example, the article may be continued on the tenth and fifteenth pages 232 of the magazine edition 112.

At stage 516, it is determined if a page is complete. For example, display generator 226 may determine whether a particular page 232 has any more available space. If there is available space on a page 232 or column 234, then a next display element 232 is retrieved from HTML document 214. If there are no more remaining display elements 232, then display generator 226 may include advertisements in any available space on the pages 232. The advertisements may be for products or services related to the contents of the edition content 132 of the page 232 or otherwise be directed to an intended audience of the magazine edition 112.

At stage 518, if the page is complete the page is displayed. For example, if display generator 226 determined that page 232 is full, that no more display elements 224 will fit onto the page 232, then the a new VPS 206 page 232 may be used to render the next display element 224 and the fall page 232 may be included with the magazine edition 112 for display. In an embodiment, display generator 226 may wait until all pages 232 have been generated for a magazine edition 112 prior to displaying magazine edition 112 on display 110. In other example embodiments, pages 232 may be displayed on a page-by-page determination.

At stage 520, it is determined whether additional elements are remaining in the stack. For example, display generator 226 may try and retrieve the next display element 224 from HTML document 214.

At stage 522, when no more display elements 224 are available on the HTML document 214, then the processing by display generator 226 may be exited, and magazine edition 112 may be provided for display on screen 210 of mobile device 106.

FIG. 6 is an example computer system 600 in which embodiments, or portions thereof, may be implemented as computer-readable code. For example, the components or modules of distributed system 100, such as studio UI 110, magazine editions 112, current module 115, studio backend 126, etc., may be implemented in one or more computer systems 600 using hardware, software, firmware, tangible computer-readable media having instructions stored thereon, or a combination thereof and may be implemented in one or more computer systems or other processing systems. Modules and components in FIGS. 1-5 may be embodied in hardware, software, or any combination thereof.

Mobile device 106, web server 104 and producer server 108 may include one or more computing devices that include a computer system 600. Computer system 600 may include one or more processors 602, one or more non-volatile storage mediums 604, one or more memory devices 606, a communication infrastructure 608, a display screen 610, a communication interface 612, and a GPU 614.

Processors 602 may include any conventional or special purpose processor, including, but not limited to, digital signal processor (DSP), field programmable gate array (FPGA), and application specific integrated circuit (ASIC).

GPU 614 is a specialized processor that executes instructions and programs, selected for complex graphics and mathematical operations, in parallel.

Non-volatile storage 604 may include one or more of a hard disk drive, flash memory, and like devices that may store computer program instructions and data on computer-readable media. One or more of non-volatile storage device 604 may be a removable storage device.

Memory devices 606 may include one or more volatile memory devices such as but not limited to, random access memory. Communication infrastructure 608 may include one or more device interconnection buses such as Ethernet, Peripheral Component Interconnect (PCI), and the like.

Typically, computer instructions are executed using one or more processors 602 and can be stored in non-volatile storage medium 604 or memory devices 606.

Display screen 610 allows results of the computer operations to be displayed to a user or an application developer.

Communication interface 612 allows software and data to be transferred between computer system 600 and external devices. Communication interface 612 may include a modem, a network interface (such as an Ethernet card), a communications port, a PCMCIA slot and card, or the like. Software and data transferred via communication interface 612 may be in the form of signals, which may be electronic, electromagnetic, optical, or other signals capable of being received by communication interface 612. These signals may be provided to communication interface 612 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments may employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments, as described, may allow others, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments as contemplated by the inventor(s), and thus, are not intended to limit the embodiments and the appended claims in any way. The breadth and scope of the present embodiments should not be limited by any of the above-described exemplary embodiments, but should be defined only in accordance with the following claims and their equivalents.

What is claimed is:

1. A computer-implemented method for displaying edition content of a magazine edition comprising:
determining dimensions of a screen of a mobile device;
generating a virtual pixel space based on the dimensions, wherein the mobile device is configured to render edition content of a magazine edition;
receiving a plurality of data structures, each data structure including a plurality of items for storing the edition content;
receiving a template associated with the magazine edition, wherein the template includes a layout for displaying the edition content and references to the plurality of items in the data structures;
binding the references from the template to the plurality of items in the data structures that include the edition content to generate display elements in an HTML document; and
generating, based on the display elements of the HTML document, the edition content of the magazine edition on the virtual pixel space for display on the screen of the mobile device.

2. The computer-implemented method of claim 1, wherein the determining is performed on the mobile device.

3. The computer-implemented method of claim 1, wherein the determining comprises:
determining whether the screen of the mobile device is configured for portrait orientation or landscape orientation;
selecting one or more portions of the HTML document corresponding to the determined orientation; and
generating, based on the display elements of the selected portions of HTML document, the edition content for the determined orientation on the virtual pixel space.

4. The computer-implemented method of claim 1, wherein the determining the configuration comprises:
determining whether the mobile device corresponds to a first device, or a second device, wherein the configuration of a screen of the first device is different from the configuration of a screen of the second device;
selecting one or more portions of the template corresponding to the determined device; and
replacing the references to the items of the data structures from the selected portions of the template with corresponding edition content of the items as display elements in the HTML document.

5. The computer-implemented method of claim 1, wherein the references comprise an extension to HTML as used within the HTML document, the data structures including the references to the items storing the edition content as retrieved from different content sources.

6. The computer-implemented method of claim 1, wherein the edition content comprises image content, textual content, and video content.

7. The computer-implemented method of claim 1, further comprising:
receiving an updated template associated with an update to the magazine edition, wherein the updated template includes an update to the layout of the edition content on the virtual pixel space; and
binding the references to the items of the data structures from the updated template with the corresponding portions of the edition content as updated display elements in an updated HTML document, wherein the items used to replace the references in the updated HTML document are the same items from the received data structures used to replace the references in the HTML document; and
generating, based on the updated display elements, the edition content on the virtual pixel space arranged based on the updated template.

8. The computer-implemented method of claim 1, further comprising:
receiving an update to the configuration of the screen;
generating an updated virtual pixel space based on the update; and
generating, based on the display elements of the HTML document corresponding to the update, the edition content on the updated virtual pixel space.

9. The computer-implemented method of claim 1, wherein the generating the virtual pixel space comprises:
determining, based on the configuration, a number of columns upon which to render the edition content on the screen; and
generating the virtual pixel space including determined the number of columns.

10. A computer-implemented method for displaying edition content of a magazine edition comprising:
generating a virtual pixel space including one or more columns as determined based on a configuration of a screen of a mobile device, wherein the mobile device is configured to render edition content of a magazine edition on the screen as arranged on the virtual pixel space;
determining an HTML document comprising display elements including the edition content as organized within the HTML document based on a template, the template including an arrangement of the edition content on the virtual pixel space; and
generating, based on the display elements of the HTML document, the edition content in the columns of the virtual pixel space for rendering on the screen.

11. The computer-implemented method of claim 10, wherein the generating, based on the display elements of the HTML document, the edition content comprises:
retrieving a display element from the HTML document;
determining if the retrieved display element fits onto a page of the virtual pixel space; and
wherein if the retrieved display element fits onto the page, generating the retrieved display element within the page of the virtual pixel space.

12. The computer-implemented method of claim 11, wherein the page of the virtual pixel space is divided into the determined columns.

13. The computer-implemented method of claim 11, comprising:
wherein if the retrieved display element does not fit onto the page, determining whether that the retrieved display element is divisible;
splitting the retrieved display element into two or more portions; and
generating the portions of the retrieved display element onto two or more pages of the virtual pixel space.

14. The computer-implemented method of claim 11, comprising:
wherein if the retrieved display element does not fit onto the page, determining whether that the retrieved display element is not divisible; and
returning the retrieved display element to the HTML document without generating the retrieved display element onto the virtual pixel space.

15. The computer-implemented method of claim 11, further comprising:
determining that the page has available space for an additional display element from the HTML document;
retrieving the additional display element from the HTML document that fits within the available space of the page; and
generating the additional display element within the available space.

16. The computer-implemented method of claim 11, further comprising:
determining that the page has available space;
determining that there are no remaining display elements in the HTML document for rendering on the virtual pixel space; and
generating an advertisement that fits in the available space.

17. The computer-implemented method of claim 11, further comprising:
determining that the page does not have any more available space;
determining that there are remaining display elements in the HTML document for rendering on the virtual pixel space; and
generating the remaining display elements on one or more additional pages of the virtual pixel space.

18. The computer-implemented method of claim 10, wherein the generating, based on the display elements of the HTML document, the edition content comprises:
determining that the HTML document is organized as a stack;
selecting a topmost element from the stack;
selecting a first one of the columns with available space upon which to render the edition content corresponding to the topmost element; and
generating the topmost element within the available space of the selected column.

19. The computer-implemented method of claim 10, wherein the generating comprises:
selecting a first one of the display elements from the HTML document;
selecting a first one of the columns with available space upon which to render the selected first display element;
determining that only a portion of the selected display element fits within the available space of the first column;
determining that the first display element is divisible;
generating a divisible portion of the selected display element in the available space of the first column; and
generating a remainder portion of selected display element in available space of a subsequent one of the columns.

20. The computer-implemented method of claim 19 wherein the remainder portion is generated on a subsequent page of the virtual pixel space relative to a page of the virtual pixel space upon which the divisible portion is generated.

21. A system for displaying edition content of a magazine edition, comprising:
a setup engine configured to generate a virtual pixel space based on a configuration of a screen of a mobile device, wherein the virtual pixel space includes one or more pages including one or more columns;
a document assembler configured to generate an HTML document from items included in data structures comprising edition content of the magazine edition and a template with references to the items in the data structures, wherein the HTML document comprises display elements including the edition content replacing the references in the template; and
a display generator configured to render the display elements corresponding to the magazine edition onto the columns of the pages, the display generator comprising:
an element injector configured to generate display elements within available space in the columns, and
an element divider configured to divide the display elements into divisible portions, wherein the element injector is configured to render the divisible portions within the available space of the columns.

22. The system of claim 21 further comprising:
an update engine configured to update the HTML document based on at least one of: an update to the template and an update to the data structures,
wherein the update engine is configured to update the template based on the update template without updating the data structures, and wherein the update engine is configured to update the data structures without updating the template.

23. The system of claim 21, wherein the setup engine is configured to generate the virtual pixel space based on whether the screen is configured for a portrait orientation or a landscape orientation.

24. The system of claim 23, wherein the display generator is configured to render the edition content of the magazine edition onto the columns of the pages of the virtual pixel space based on the orientation, wherein the display elements for portrait orientation are arranged differently than the display elements for the landscape orientation on the virtual pixel space.

25. A computer-implemented method for displaying edition content of a magazine edition comprising:
generating columns on a page of a virtual pixel space based on a configuration of a screen of a mobile device;
receive an HTML document comprising display elements organized within the HTML document based on a template, the template comprising a layout of the edition content for the magazine edition;
generating the edition content on the virtual pixel space based on the display elements, wherein the generated edition content is organized into the columns and pages of the virtual pixel space; and
rendering the virtual pixel space of the magazine edition on the screen of the mobile device.

26. An apparatus comprising a non-transitory computer readable medium encoding instructions thereon that in response to execution by a computing device cause the computing device to perform operations for displaying edition content of a magazine edition, the operations comprising:
determining a plurality of data structures, each data structure including plurality of items for storing edition content;
determining a template associated with the magazine edition, wherein the template includes a layout for displaying the edition content and references to the items;
determining dimensions of a screen for each of the mobile devices, wherein the dimensions of a first screen of a first mobile device vary from the dimensions of a second screen of a second mobile device;
generating a virtual pixel space for each of the screens of the mobile devices, each respective virtual pixel space having dimensions corresponding to a respective one of the screens;
binding the references to the items of the data structures from the template with corresponding portions of the edition content to generate display elements in an HTML document; and
generating, based on the display elements of the HTML document, the edition content of the magazine edition for the virtual pixel spaces in a preview of the screens.

27. The apparatus of claim 26, wherein the operations further comprise:
providing the template and the data structures to one or more of the mobile devices, wherein each respective mobile device is configured to render the magazine edition on its respective screen.

28. The apparatus of claim 26, wherein the operations further comprise:
providing the HTML document to one or more of the mobile devices, wherein each respective mobile device is configured to render the magazine edition on its respective screen.
